(19) United States
(12) Patent Application Publication
(10) Pub. No.: US 2010/0062188 A1
(43) Pub. Date: Mar. 11, 2010

(54) POLYIMIDE FILM HAVING SMOOTHNESS ON ONE SURFACE

(75) Inventors: Takao Miyamoto, Ube (JP); Hideki Iwai, Ube (JP); Toshiyuki Nishino, Ube (JP); Yasuhiro Nagoshi, Ube (JP)

Correspondence Address: NIXON PEABODY, LLP, 401 9TH STREET, NW, SUITE 900, WASHINGTON, DC, 20004-2128, US

(73) Assignee: UBE INDUSTRIES, LTD., Ube-shi, Yamaguchi (JP)

(21) Appl. No.: 12/595,736

(22) PCT Filed: Apr. 14, 2008
(86) PCT No.: PCT/JP2008/057274

§ 371 Date: Oct. 13, 2009

(30) Foreign Application Priority Data
Apr. 13, 2007 (JP) 2007-105551

(51) Int. Cl. C09K 19/00; B32B 7/02; B05D 5/12

(52) U.S. Cl. 428/1.6; 428/212; 427/58

(57) ABSTRACT

A polyimide film having one smooth surface favorably employable for a substrate of a display or an electronic paper is prepared by the steps of forming a laminated film by coating a polyimide precursor solution containing no filler, in which the polyimide is prepared from an acidic component comprising 3,3′,4,4′-biphenyltetracarboxylic dianhydride and a diamine component comprising p-phenylene diamine, on one surface of a self-supporting film of a polyimide precursor solution containing a filler, in which the polyimide is prepared from an acidic component comprising 3,3′,4,4′-biphenyltetracarboxylic dianhydride and a diamine component comprising p-phenylene diamine; and heating the laminated film to perform imidization.

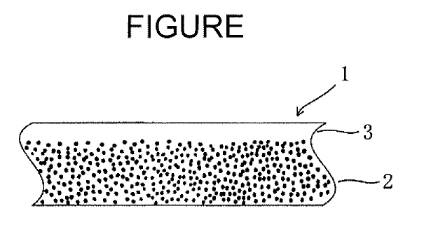

### FIELD OF THE INVENTION

The present invention relates to a polyimide film having high modulus of elasticity and high heat resistance and further having high smoothness on one surface which is favorably employable as a substrate of an information display device such as a liquid crystal display, an organic electroluminescence display, or an electronic paper or a substrate of an electric or electronic device such as a solar cell. The invention further relates to an information display device such as a liquid crystal display, an organic electroluminescence display or an electronic paper and an electric or electronic device such as a solar cell.

### BACKGROUND OF THE INVENTION

An aromatic polyimide film is widely employed for the use as a substrate of a variety of electronic devices due to its excellent dimensional stability, thermal characteristics and electronic characteristics.

Japanese Patent Provisional Publication 2006-336009 describes the use of an aromatic polyimide film as a base material for a liquid crystal display or an electronic paper.

Japanese Patent Provisional Publication 2003-160677 describes a base film of a magnetic tape which comprises polyimide showing no apparent glass transition temperature (Tg) in the temperature range from room temperature to 500° C. and has a thickness of not less than 5 μm, but less than 10 μm and a modulus in tension in the range of 9,000 to 15,000 Pa, the base film having at least one smooth surface showing Ra of 1.00 nm or less. The base film for a magnetic tape can be prepared by simultaneously coating two kinds of polyamic solutions.

Japanese Patent Provisional Publication 63-297038 describes a method comprising coating a polyimide precursor solution on a self-supporting film.

### SUMMARY OF THE INVENTION

Accordingly, it is an object of the invention to provide a polyimide film which is obtained from an acidic component comprising 3,3′,4,4′-biphenyltetracarboxylic dianhydride and a diamine component comprising p-phenylene diamine and which has a smooth surface on one side and a rough surface on another side. The polyimide film is favorably employable for manufacturing a substrate, particularly a base material, of a display or an electronic paper.

There is provided by the invention a polyimide film having a thickness in the range of 20 to 150 μm which comprises a lower filler-containing polyimide resin layer comprising a polyimide resin prepared from an acidic component comprising 3,3′,4,4′-biphenyltetracarboxylic dianhydride and a diamine component comprising p-phenylene diamine and a filler dispersed in the polyimide resin and an upper polyimide resin layer comprising a polyimide resin prepared from an acidic component comprising 3,3′,4,4′-biphenyltetracarboxylic dianhydride and a diamine component comprising p-phenylene diamine formed continuously on the lower filler-containing polyimide resin layer, in which the polyimide film has a surface showing Ra of more than 1.0 nm but not more than 2.5 nm on the side of the filler-containing polyimide resin layer and a surface showing Ra of 1.0 nm or less on a reverse side.

The polyimide film of the invention can be prepared by a process comprising the steps of:
forming a laminated film by coating a polyimide precursor solution containing no filler, the polyimide being prepared from an acidic component comprising 3,3′,4,4′-biphenyltetracarboxylic dianhydride and a diamine component comprising p-phenylene diamine, on one surface of a self-supporting film comprising a polyimide precursor solution containing a filler, the polyimide being prepared from an acidic component comprising 3,3′,4,4′-biphenyltetracarboxylic dianhydride and a diamine component comprising p-phenylene diamine; and
heating the laminated film to perform imidization.

The polyimide film of the invention can be also prepared by a process comprising the steps of:
obtaining a self-supporting film by the steps of:
   producing a filler-containing polyimide precursor solution film by spreading a filler-containing polyimide precursor solution on a smooth surface of a support, the polyimide precursor being prepared from an acidic component comprising 3,3′,4,4′-biphenyltetracarboxylic dianhydride and a diamine component comprising p-phenylene diamine;
   drying the filler-containing polyimide precursor solution film, whereby producing a self-supporting film containing a filler and a solvent;
   separating the self-supporting film from the surface of the support; and
   heating the separated self-supporting film whereby evaporating a portion of the solvent;
coating a polyimide precursor solution containing no filler, the polyimide precursor solution being prepared from an acidic component comprising 3,3′,4,4′-biphenyltetracarboxylic dianhydride and a diamine component comprising p-phenylene diamine, on a surface of the solution-containing self-supporting film, the surface having been not in contact with the surface of the smooth surface of the support in the steps for preparing the solution-containing self-supporting film;
and
heating the laminated film to perform imidization.

Preferred embodiments of the invention are set forth below.
(1) The upper polyimide resin layer contains no filler or a filler in an amount less than an amount of the filler contained in the lower filler-containing polyimide resin layer.
(2) The upper polyimide resin layer has a thickness in the range of 0.6 to 1.2 μm.
(3) The filler is selected from the group consisting of a titanium dioxide powder, a silicon dioxide powder, a magnesium oxide powder, an aluminum oxide powder, a zinc oxide powder, a silicon nitride powder, a titanium nitride powder, a silicon carbide powder, a calcium carbonate powder, a calcium sulfate powder, a barium sulfate powder, a polyimide fine fiber, a polyimide particle powder, a polyamide fine powder, and a polyamide particle powder.

### EFFECTS OF THE INVENTION

The polyimide film having one smooth surface according to the invention has high modulus of elasticity, high thermal resistance and high flexing resistance, and hence is favorably employable for manufacturing a substrate, particularly a base material, of a display or an electronic paper.

### PREFERRED EMBODIMENTS OF THE INVENTION

The present invention is explained by referring to the attached drawing. In FIGURE, a polyimide film 1 comprises a filler-containing polyimide resin layer (area) 2 and a polyimide resin layer (area) 3 containing no filler. The no filler-containing polyimide resin layer 3 is placed on the filler-containing polyimide resin layer 2 continuously with no observable border face.

In the polyimide film of the invention, a portion of each particle of the fine filler such as an inorganic filler or an organic filler is embedded and held in its one surface to form a rough surface having a large number of fine protrusions thereon. The surface on the reverse side has no or almost no fine filler thereon to give a smooth surface. The layer having essentially no filler thereon is formed on the filler-containing layer continuously.

The smooth surface of the polyimide film has Ra (an index indicating smoothness) of 1.0 nm or less, preferably in the range of 0.01 to 1.0 nm, more preferably in the range of 0.05 to 0.9 nm, further preferably in the range of 0.1 to 0.8 nm, specifically preferably in the range of 0.1 to 0.4 nm. The rough surface is so formed that the polyimide film can be continuously passed in a transfer machine, and has a higher Ra, preferably more than 1.0 nm but not more than 2.5 nm, more preferably more than 1.1 nm but not more than 2.5 nm, further preferably more than 1.2 nm but not more than 2.0 nm, further preferably more than 1.2 nm but not more than 1.8 nm, specifically preferably more than 1.3 nm but not more than 1.7 nm. The polyimide film having one rough surface having Ra of more than 1.0 nm but not more than 2.0 nm, specifically Ra of more than 1.2 nm but not more than 1.8 nm, more specifically Ra of more than 1.3 nm but not more than 1.7 nm is preferred because the polyimide having such rough surface does not damage the smooth surface on the reverse side when the polyimide film is wound around a roll.

The self-supporting film was prepared from a single thin layer film extruded onto a support (belt). Therefore, one surface of the self-supporting film has been kept in contact with the support surface, while another surface has been exposed to a gaseous phase (air, etc.). Generally, the surface having been exposed to a gaseous phase (air, etc.) was named “A surface”, while the surface having been kept in contact with the support surface is named “B surface”.

The smooth surface of the polyimide film preferably has the following surface smoothness:
1) Mean square roughness (Rms) is not more than 1.5 nm, further more than 0.01 nm but not more than 1.5 nm, specifically more than 0.05 nm but not more than 1.3 nm;
2) Maximum roughness (Rmax) is not more than 25 nm, further more than 0.01 nm but not more than 25 nm, furthermore more than 0.05 nm but not more than 22 nm, specifically more than 0.1 nm but not more than 15 nm.

The rough surface of the polyimide film preferably has the following surface smoothness:
1) Mean square roughness (Rms) is more than the corresponding value of the smooth surface, and more than 1.3 nm but not more than 4 nm, further more than 1.5 nm but not more than 3 nm, specifically more than 2 nm but not more than 3 nm;
2) Maximum roughness (Rmax) is more than the corresponding value of the smooth surface, and more than 15 nm but not more than 80 nm, further more than 22 nm but not more than 70 nm, specifically more than 25 nm but not more than 65 nm.

Specifically, if the polyimide film satisfies both of the above-mentioned conditions, the polyimide film can be continuously transferred in a transfer machine without damaging the smooth surface.

The polyimide precursor employed for the preparation of the polyimide film of the invention is a polyamic acid or a polyamide acid which is obtained from an acid component comprising 3,3′,4,4′-biphenyltetracarboxylic dianhydride (comprising 3,3′,4,4′-biphenyltetracarboxylic dianhydride in an amount of preferably 50 to 100 molar %, more preferably 80 to 100 molar %, further preferably 90 to 100 molar %, specifically preferably 95 to 100 molar %) and a diamine component comprising p-phenylene diamine (comprising p-phenylene diamine in an amount of preferably 50 to 100 molar %, more preferably 80 to 100 molar %, further preferably 90 to 100 molar %, specifically preferably 95 to 100 molar %).

The acid component may contain a known acid dianhydride, preferably an aromatic acid dianhydride in addition to the 3,3′,4,4′-biphenyltetracarboxylic dianhydride, provided that the contained acid dianhydride does not give adverse effect to the characteristics of the polyimide. Examples of the known acid dianhydride include pyromellitic dianhydride, 2,3,3′,4′-biphenyltetracarboxylic dianhydride, 3,3′,4,4′-benzophenonetetracarboxylic dianhydride, bis(3,4-dicarboxyphenyl)ether dianhydride, bis(3,4-dicarboxyphenyl)sulfide dianhydride, bis(3,4-dicarboxyphenyl)sulfone dianhydride, 2,2-bis(3,4-dicarboxyphenyl)propane dianhydride, and 2,2-bis(3,4-dicarboxyphenyl)-1,1,1,3,3,3-hexafluoropropane dianhydride. The known acid dianhydrides can be employed alone or in combination.

The diamine component may contain a known diamine compound, preferably an aromatic diamine, provided that the contained diamine compound does not give adverse effect to the characteristics of the polyimide. Examples of the known diamine compound include m-phenylene diamine, 3,3′-dimethyl-4,4′-diaminobiphenyl, 3,3′-dihydroxy-4,4′-diaminobiphenyl, 3,3′-dicarboxy-4,4′-diaminobiphenyl, 3,3′-dimethoxy-4,4′-diaminobiphenyl, 3,3′,5,5′-tetramethyl-4,4′-diaminobiphenyl, 4,4′-methylene-bis(2-methylaniline), 4,4′-methylene-bis(2-ethylaniline), 4,4′-methylene-bis(2-isopropylaniline), 4,4′-methylene-bis-(2,6-dimethylaniline), 4,4′-methylene-bis(2,6-diethylaniline), 4,4′-methylene-bis(2,6-diisopropylaniline), 3,3′-dihydroxy-4,4′-diaminodiphenylmethane, 3,3′-dicarboxy-4,4′-diaminodiphenylmethane, 3,3′-dicarboxy-4,4′-diamino-5,5′-dimethyldiphenylmethane, and o-toluidinesulfone. The known diamine compounds can be employed alone or in combination.

The polyimide film of the invention which has an upper smooth surface and a lower rough surface can be prepared by the steps of coating a polyimide precursor solution containing essentially no filler (or containing a filler in a less amount than the content of a filler in the below-mentioned filler-containing polyimide precursor solution) on a self-supporting film of a filler-containing polyimide solution, and heating the coated film for performing imidaization.

In more detail, the polyimide film can be preferably prepared by the steps of extruding a filler-containing polyimide precursor solution from a die of a film-forming apparatus in the form of a solution film onto a surface of a support (belt) to form a solution film having a uniform thickness, heating the solution film at 100-180° C. for 2-60 minutes until a most portion of the solvent is evaporated to give a self-supporting film, separating the self-supporting film from the support, coating a polyimide precursor solution containing no filler on the A surface of the self-supporting film, fixing thus coated self-supporting film by means of pin tenters, clips or metallic elements, and heating the fixed coated self-supporting film. In the first step, the filler serves as a lubricant.

The above-mentioned heating step preferably comprises a first heating stage at 200-300° C. (not inclusive 300° C.) for 1 to 60 minutes, a second heating stage at 300-370° C. for 1 to 60 minutes, and a third heating stage at 350-580° C., preferably at a maximum temperature of 370-550° C., for 1 to 30 minutes. These heating stages can be performed in known heating apparatus such as a hot gas-blowing furnace and an infrared heating furnace.

The self-supporting film of the polyimide precursor solution can be prepared by adding the filler to a solution of a polyimide precursor in an organic solvent, spreading the precursor solution on a support, and heating the coated precursor solution until the spread precursor solution turns to a self-supporting film. The last procedure is performed in advance of the known curing procedure. If required, an imidization catalyst and an organic phosphorus compound are also added to the polyimide precursor solution.

The polyimide precursor solution containing no filler is coated on one surface of the self-supporting film in such an amount that the coated precursor solution does not cause production of cracks in the self-supporting film and can almost or completely cover protrusions comprising filler particles formed on the self-supporting film. Preferably, the polyimide precursor solution is coated to give a film having a thickness (after dryness) in the range of 0.6 to 1.2 μm.

The polyimide precursor solution containing no filler can be coated on one surface, preferably A surface, of the self-supporting film by the known coating procedures such as gravure coating, spin coating, silk screen coating, dip coating, spray coating, bar coating, roller coating, blade coating, and die coating.

The polyimide precursor solution can be prepared by subjecting essentially equimolar amounts of the acid component and diamine component to random polymerization or block polymerization in an organic solvent, preferably, at 10 to 80° C. for 1 to 30 hours. Otherwise, the acid component and diamine component in such amounts that one of the components is in an excessive amount are reacted to give one reaction mixture. Further, the acid component and diamine component in such amounts that another of the components is in an excessive amount are reacted to give another reaction mixture. Subsequently, the two reaction mixtures are mixed and subjected to a reaction to give a polyimide precursor solution. Thus prepared polyimide precursor solution can be employed as such or with addition of a solvent or removal of a portion of the solvent for the preparation of the self-supporting film.

The polyimide precursor solution for the preparation of the self-supporting film preferably has a polymer (polyimide precursor having an imidization ratio of not more than 5%) having a concentration of 10 to 25 wt. % and a rotary viscosity (30° C.) in the range of 500 to 4,500 poise and contains a polymer having a logarithmic viscosity in the range of 1 to 5 (measurement temperature: 30° C., concentration: 0.5 g/100 mL, solvent: N-methyl-2-pyrrolidone).

The polyimide precursor solution for coating is a film-forming precursor solution and can be coated by a conventional procedure to give a film fixed to the self-supporting film. The polyimide precursor solution for coating which contains no or less amount of a filler) can be prepared from the same polyimide precursor solution for the self-supporting film except for containing no filler or a less amount of filler after dilution. Otherwise, the precursor solution can be prepared using less amounts of the components to give a solution having a lower polymer concentration. Thus prepared precursor solution can be diluted to show an appropriate solution viscosity for the coating. The polyimide precursor solution for coating preferably has a polymer concentration in the range of 5 to 6 wt. % and contains the polyimide precursor (imidization ratio: not more than 5%) showing a rotary viscosity (30° C.) in the range of 0.05 to 0.15 poise.

The self-supporting film of the polyimide precursor solution can be prepared by spreading a polyimide precursor solution containing a filler, optionally an imidaization catalyst and an organic phosphorus compound, on a support and heating the spread solution at 100-180° C. for 2-60 minutes so that the solution film turns to a self-supporting film which can be separated from the support. The polyimide precursor solution preferably contains the polyimide precursor in an amount of 10 to 30 wt. %. The polyimide precursor solution preferably has a polymer concentration in the range of 8 to 25 wt. %. The support can be a stainless plate or a stainless belt.

The separated self-supporting film should be coated on one surface with a polyimide precursor solution containing essentially no filler uniformly to give a smooth surface. For this reason, the self-supporting film should be prepared under such conditions that it can be easily subjected to the coating procedure.

In more detail, it is preferred that the self-supporting film shows an ignition loss (essentially corresponding to content of the solvent) in the range of 20 to 40 wt. % and contains a polyimide precursor of an imidization ratio in the range of 8 to 40%. Thus prepared self-supporting film generally has enough physical properties so that the self-supporting film does not show bubbles and cracks after the imidization is complete. The above-mentioned ignition loss can be calculated according to the following equation:

Ignition loss (wt. %)=[(W₁−W₂) /W₁]×100

in which W₁ means an original weight and W₂ means a weight after heating the film at 420° C. for 20 minutes.

The imidaization ratio of the self-supporting film can be determined by obtaining IR (ATR) and comparing the peak areas in the specific frequency area between a film to be tested and a full-cured film. For instance, the peak in the specific frequency is a peak corresponding to symmetric stretching vibration of the imidocarbonyl group or a peak corresponding to symmetric stretching vibration of the benzene ring structure. Otherwise, the imidaization ratio can be determined by means of a Karl-Fischer water content-measuring apparatus which is described in Japanese Patent Provisional Publication 9-316199.

Examples of the organic solvent for the polyimide precursor solution include N-methyl-2-pyrrolidone, N,N-dimethylformamide, N,N-dimethylacetamide and N,N-diethylacetamide. The organic solvents can be employed alone or in combination.

As described hereinbefore, the polyimide precursor solution for the preparation of the self-supporting film may contain an imidization catalyst and an organic phosphorus compound. The polyimide precursor solution for the coating also may contain an imidization catalyst and an organic phosphorus compound.

Examples of the imidaization catalyst can be substituted or unsubstituted nitrogen-containing heterocyclic compounds, N-oxide compounds of the heterocyclic compounds, substituted or unsubstituted amino acid compounds, aromatic hydrocarbon compounds or aromatic heterocyclic compounds having a hydroxyl group. In more detail, the examples include imidazoles such as lower alkyl imidazoles, for instance, 1,2-dimethylimidazole, N-methylimidazole, N-benzyl-2-methylimidazole, 2-methylimidazole, 2-ethyl-4-imidazole and 5-methylbenzimidazole and benzimidazoles, for instance, N-benzyl-2-methylimidazole; quinolines such as isoquinoline; and substituted pyridines such as 3,5-dimethylpyridine, 3,4-dimethylpyridine, 2,5-dimethylpyridine, 2,4-dimethylpyridine and 4-n-propylpyridine. The imidazoles such as 1,2-dimethylimidazole are most preferred. The imidaization catalyst preferably can be employed in an amount of 0.01 to 2 equivalent, particularly 0.02 to 1 equivalent based on the amide acid moiety of the polyamic acid (polyimide precursor). If the imidaization catalyst is employed, the resulting polyimide film shows improved properties, specifically an improved tear resistance.

The organic phosphorus compound can be a phosphate or an amine salt of a phosphate. Examples of the phosphate include monocaproyl phosphate, monooctyl phosphate, monolauryl phosphate, monomyrityl phosphate, monocetyl phosphate, monostearyl phosphate, monophosphate of triethyleneglycol monodecyl ether, monophosphate of tetraethyleneglycol monolauryl ether, monophosphate of diethyleneglycol monostearyl ether, dicaproyl phosphate, dioctyl phosphate, dicapryl phosphate, dilauryl phosphate, dimyristyl phosphate, dicetyl phosphate, distearyl phosphate, diphosphate of tetraethyleneglycol mononeopentyl ether, diphosphate of triethyleneglycol tridecyl ether, diphosphate of tetraethyleneglycol monolauryl ether and diphosphate of diethyleneglycol monostearyl ether. Examples of the amine for forming the amine salt include ammonia, monomethylamine, monoethylamine, monopropylamine, monobutylamine, dimethylamine, diethylamine, dipropylamine dibutylamine, trimethylamine, triethylamine, tripropylamine, tributylamine, monoethanolamine, diethanol amine and triethanolamine.

The filler employed for the preparation of the polyimide film can serve for providing smoothness to the film and for winding the film around a roll smoothly and separating the film from the roll smoothly. Examples of the filler include fine inorganic oxide powders such as titanium dioxide powder, silicon dioxide (silica) powder, magnesium oxide powder, aluminum oxide (alumina) powder, and zinc oxide powder; fine inorganic nitride powders such as silicon nitride powder and titanium nitride powder; inorganic carbide powder such as silicon carbide powder; other fine inorganic powders such as calcium carbonate powder, calcium sulfate powder and barium sulfate powder; and organic fillers such as polyimide fine fibers, polyimide particle powder, polyamide fine fibers and polyamide particle powder. The fillers can be employed in combination. The fillers can be dispersed in the polyimide precursor solution uniformly by known method.

The particle size of the filler can be so determined as to improve the smoothness of the film in its preparation and the smoothness of the film winding. The filler preferably has a mean particle diameter of 0.005 to 0.5 μm, more preferably 0.405 to 0.1 μm, most preferably 0.01 to 0.1 μm.

The polyimide film having the smooth surface can be employed as such or, if required, after subjecting to a surface processing procedure such as corona discharge, low temperature plasma discharge, ordinary temperature plasma discharge, or chemical etching as a base film of an information display device or an electric-electronic device.

On one or both surfaces of the polyimide film can be provided a gas barrier layer, an electroconductive layer, a semiconductor layer or a light-emitting layer, for the use in electric devices and electronic devices. These layer can be provided on the polyimide film by known methods such as vapor deposition, ion-plating, sputtering, and plasma CVD.

The polyimide film of the invention has excellent heat resistance, flexing resistance and modulus in tension. For instance, the modulus in tension is generally in the range of 6,500 to 15,000 MPa, preferably in the range of 9,000 to 12,000 MPa. The linear expansion coefficient (50-200° C.) is generally in the range of 5×10⁻⁶ to 25×10⁻⁶ cm/cm/° C., preferably in the range of 10×10⁻⁶ to 20×10⁻⁶ cm/cm/° C. The thickness is generally in the range of 20 to 150 μm, preferably in the range of 35 to 100 μm. Therefore, the polyimide film is favorably employable as a base film of an information display device or an electric-electronic device.

The polyimide film shows a kinetic friction coefficient of generally 0.40 or less, preferably 0.36 or less, more preferably 0.33 or less, further preferably 0.30 or less, most preferably 0.27 or less, in which the kinetic friction coefficient is measured between the smooth surface and rough surface. Therefore, the polyimide film is favorably employed as a base material of a liquid crystal display, an electroluminescence display and an electronic paper. The polyimide film shows a static friction coefficient of generally 0.40 or less, preferably 0.36 or less, more preferably 0.33 or less, further preferably 0.30 or less, most preferably 0.27 or less. Therefore, the polyimide film is favorably employed as a base material of a liquid crystal display, an electroluminescence display and an electronic paper.

### EXAMPLES

The present invention is further described by the following examples.

### [Measuring Method]

### <Measurement of Surface Smoothness>

A film is cut to give specimen of an appropriate size, which is then fixed onto a plate using a double adhesive-coated tape. The plate having the specimen is fixed onto a stage using a magnetic element for subjecting to AFM measurement.

Apparatus and Measuring Conditions
(1) D3100 type scanning probe microscope (SPM) available from Digital Instrument (Beaco Corporation)
(2) Control station: Nanoscope IIIa type
(3) Tapping mode atomic force microscope (AFM)
(4) Scanning size: 10×10 μm (number of data pixel: 512×512)

### <Physical Properties of Polyimide Film>

The modulus in tension is determined according to ASTM D882.

### <Determination of Friction Coefficient>

The kinetic friction coefficient between the A surface and B surface of the film and the static friction coefficient are determined according to ASTM D1894.

### <Thermal Characteristics of Polyimide Film>

The coefficient of linear expansion is determined at 50 to 200° C. at a temperature elevation of 5° C./min.

### Reference Example 1

### Preparation of a Polyimide Precursor Solution for Preparing a Self-Supporting Film

3,3′,4,4′-biphenyltetracarboxylic dianhydride and p-phenylenediamine were polymerized in N,N-dimethylacetamide at 40-50° C. for 30 hours, to give a polyamic acid solution having a polymer content of 18 wt. % and a solution viscosity of 1,800 poises (30° C., rotary viscometer). To the polyamic acid solution were added 0.1 weight part of monostearyl phosphate triethanolamine salt and 0.5 weight part of colloidal silica (mean diameter: 800 angstrom) based on 100 weight part of the polyamic acid, to give a polyimide precursor solution for preparing a self-supporting film.

### Reference Example 2

### Preparation of a Polyimide Precursor Solution for Coating

In N,N-dimethylacetamide, 3,3′,4,4′-biphenyltetracarboxylic dianhydride and p-phenylene diamine were placed at a molar ratio of 95:100 and subjected to polymerization, to give a polyamic acid solution having a polymer content of 5.5 wt. % and a solution viscosity of 0.1 poise (30° C., vibration viscometer). Subsequently, 3,3′,4,4′-biphenyltetracarboxylic acid (s-BPTA) was added in such an amount to adjust the molar ratio to an equivalent ratio, to give a polyamic acid solution. The resulting polyamic acid solution was filtered over a filter having an aperture size of 20 μm, to obtain a polyimide precursor solution for coating.

### Example

The polyimide precursor solution obtained in Reference Example 1 was continuously extruded at 30° C. (extrusion temperature) from a die provided to a film manufacturing apparatus onto a metallic belt having a smooth surface which was continuously circulated over a pair of rotating drums to give a solution film on the circulating belt. The solution film was then introduced into a curing furnace in which the upper surface of the solution film was exposed to blowing hot air at approx. 140° C. for 6 minutes, to give a self-supporting film (solvent content: 30 to 40 wt. %). The self-supporting film was then separated from the belt.

The polyimide precursor solution obtained in Reference Example 2 was coated on A surface of the self-supporting film using a gravure coater to give a film having a thickness after dryness in the range of 0.8 to 1.0 μm. Thus coated self-supporting film was passed in a curing furnace equipped therein with an infrared heater, whereby heating the coated self-supporting film at temperatures gradually elevating from 150 to 450° C. for 4 minutes, to a film. The film was then cooled to room temperature and wound around a roll of a winding machine, to finally obtain an aromatic polyimide film having a thickness of 50 μm.

The obtained aromatic polyimide film was subjected to measurements of its characteristics.
1) Surface Smoothness
   Surface on the coated side: Ra=0.95 nm, Rms=1.21 nm, Rmax=21.3 nm
   Surface having no coating: Ra=1.55 nm, Rms=2.45 nm, Rmax=57.4 nm
2) Physical Characteristics
   Modulus in tension: 9,850 MPa (mean value in MD and TD)
3) Friction Coefficient
   kinetic friction coefficient: 0.34
   Static friction coefficient: 0.35
4) Coefficient of Linear Expansion (50-200° C.)
   MD (machine direction): 12 ppm/° C.
   TD (traverse direction): 12.2 ppm/° C.

### UTILITY IN INDUSTRY

The polyimide film of the invention having a smooth surface on one side shows excellent heat resistance and modulus in tension and appropriate friction coefficients and coefficient of linear expansion. Therefore, the polyimide film can be favorably employed as a base material of a liquid crystal display, an organic electroluminescence display or an electronic paper.

### BRIEF EXPLANATION OF DRAWING

FIGURE shows schematically shows a section of a polyimide film having a smooth surface on one side according to the invention.

1: polyimide film,

2: filler-containing polyimide resin layer,

3: no filler-containing polyimide resin layer

What is claimed is:

1. A polyimide film having a thickness in the range of 20 to 150 μm which comprises a lower filler-containing polyimide resin layer comprising a polyimide resin prepared from an acidic component comprising 3,3′,4,4′-biphenyltetracarboxylic dianhydride and a diamine component comprising p-phenylene diamine and a filler dispersed in the polyimide resin and an upper polyimide resin layer comprising a polyimide resin prepared from an acidic component comprising 3,3′,4,4′-biphenyltetracarboxylic dianhydride and a diamine component comprising p-phenylene diamine formed continuously on the lower filler-containing polyimide resin layer, in which the polyimide film has a surface showing Ra of more than 1.0 nm but not more than 2.5 nm on the side of the filler-containing polyimide resin layer and a surface showing Ra of 1.0 nm or less on a reverse side.

2. The polyimide film of claim 1, in which the upper polyimide resin layer contains no filler or a filler in an amount less than an amount of the filler contained in the lower filler-containing polyimide resin layer.

3. The polyimide film of claim 1, in which the upper polyimide resin layer has a thickness in the range of 0.6 to 1.2 μm.

4. The polyimide film of claim 1, in which the filler is selected from the group consisting of a titanium dioxide powder, a silicon dioxide powder, a magnesium oxide powder, an aluminum oxide powder, a zinc oxide powder, a silicon nitride powder, a titanium nitride powder, a silicon carbide powder, a calcium carbonate powder, a calcium sulfate powder, a barium sulfate powder, a polyimide fine fiber, a polyimide particle powder, a polyamide fine powder, and a polyamide particle powder.

5. A substrate of a liquid crystal display, an electroluminescence display, or an electronic paper which comprises a polyimide film of claim 1.

6. An information display device or an electric-electronic device equipped with a polyimide film of claim 1.

7. A process for preparing a polyimide film of claim 1, which comprises the steps of:
forming a laminated film by coating a polyimide precursor solution containing no filler, the polyimide being prepared from an acidic component comprising 3,3′,4,4′-biphenyltetracarboxylic dianhydride and a diamine component comprising p-phenylene diamine, on one surface of a self-supporting film comprising a polyimide precursor solution containing a filler, the polyimide being prepared from an acidic component comprising 3,3′,4,4′-biphenyltetracarboxylic dianhydride and a diamine component comprising p-phenylene diamine; and
heating the laminated film to perform imidization.

8. A process for preparing a polyimide film of claim 1, which comprises the steps of:
obtaining a self-supporting film by the steps of:
producing a filler-containing polyimide precursor solution film by spreading a filler-containing polyimide precursor solution on a smooth surface of a support, the polyimide precursor being prepared from an acidic component comprising 3,3′,4,4′-biphenyltetracarboxylic dianhydride and a diamine component comprising p-phenylene diamine;
drying the filler-containing polyimide precursor solution film, whereby producing a self-supporting film containing a filler and a solvent;
separating the self-supporting film from the surface of the support; and
heating the separated self-supporting film whereby evaporating a portion of the solvent;
coating a polyimide precursor solution containing no filler, the polyimide precursor solution being prepared from an acidic component comprising 3,3′,4,4′-biphenyltetracarboxylic dianhydride and a diamine component comprising p-phenylene diamine, on a surface of the solution-containing self-supporting film, the surface having been not in contact with the surface of the smooth surface of the support in the steps for preparing the solution-containing self-supporting film;
and
heating the laminated film to perform imidization.
